(19) United States
(12) Patent Application Publication
(10) Pub. No.: US 2005/0107508 A1
(43) Pub. Date: May 19, 2005

(54) Mono or biaxially oriented, flame-retardant polyester film

(76) Inventors: Jae-Suk Joo, Suwon-si (KR); Gwan-Hyung Lee, Suwon-si (KR); Yong-Won Kim, Suwon-si (KR)

Correspondence Address: David A. Einhom, Esq.;Anderson Kill & Olick, P.C., 1251 Avenue of the Americas, New York, NY, 10020, US

(21) Appl. No.: 10/968,493

(22) Filed: Oct. 19, 2004

(30) Foreign Application Priority Data
Oct. 20, 2003 (KR) 10-2003-0073132

(51) Int. Cl. C08K 3/32; C08K 3/38

(52) U.S. Cl. 524/404; 524/414

(57) ABSTRACT

The mono or biaxially oriented polyester film of the present invention having improved flame-retardancy and processibility comprises a polyester resin having an intrinsic viscosity of 0.4 to 0.9 dl/g which contains, in its polyester chain derived from dicarboxylic acid and diol components, an incorporated repeat unit of formula (I) in an amount of 10 to 30 mol % based on the amount of dicarboxylic acid, and a flame-retardancy enhancing agent in an amount ranging from 0.05 to 5% by weight based on the weight of the polyester resin.

### FIELD OF THE INVENTION

The present invention is directed to a mono or biaxially oriented polyester film having improved flame-retardancy.

### BACKGROUND OF THE INVENTION

Flame-retardant films have been widely used in electrical and interior applications, e.g., electric power cable, communication cable, printed circuit plate, heating unit and the like.

As polyester films, in particular polyethylene terephthalate films, have relatively high flammability, there have been attempts to prepare polyester films having low flammability by way of adding thereto a halogen- or phosphorus-based flame-retardant. However, the halogen-based flame-retardant has the problem of generating toxic gases on combustion, and the phosphorus-based compound is used in relatively large amount to achieve satisfactory flame-retardancy, which results in poor processibility such as ununiform drawing.

Accordingly, in order to solve these problems, there have been reported studies to laminate a layer of a mixture of a flame-retardant and heat-resistant resin, or to co-extrude them together (Japanese Laid-open Publication Nos. 1993-54427 and 1993-69448). However, the film products prepared thereby do not exhibit satisfactory flame-retardancy and processibility.

### SUMMARY OF THE INVENTION

Accordingly, it is an object of the present invention to provide a polyester film having improved flame-retardancy and processibility.

In accordance with the present invention, there is provided a mono or biaxially oriented, flame-retardant polyester film which comprises: a polyester resin having an intrinsic viscosity of 0.4 to 0.9 dl/g which contains, in its polyester chain derived from dicarboxylic acid and diol components, an incorporated repeat unit of formula (I) in an amount of 10 to 30 mol % based on the amount of dicarboxylic acid, and a flame-retardancy enhancing agent in an amount ranging from 0.05 to 5% by weight based on the weight of the polyester resin: 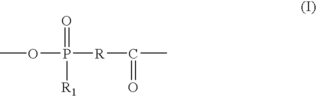
wherein,
R is C₁₋₁₂ saturated alkylene having an optional aryl substituent or arylene group inserted therein, or arylene; and
R₁ is C₁₋₁₂ alkyl having an optional aryl substituent, or aryl.

### DETAILED DESCRIPTION OF THE INVENTION

The mono or biaxially oriented polyester film according to the present invention is characterized in that it is prepared by copolymerizing a dicarboxylic acid component, a diol component and a phosphorus-based flame-retardant, and adding a flame-retardancy enhancing agent to the copolymerized polyester resin.

The polyester resin suitable for the present invention may be prepared by polymerizing a dicarboxylic acid component and a diol component, followed by introducing a bifunctional phosphorus compound, by copolymerizing with the dicarboxylic acid and diol components, in an amount ranging 10 to 30 mol %, preferably 10 to 20 mol % based on the amount of the dicarboxylic acid component.

The dicarboxylic acid and diol components used in the present invention may be any those used in the manufacture of conventional polyester resins.

The bifunctional phosphorus compound, which is used in the present invention as a flame retarding component incorporated in the polyester chain in the form of formula (I), is preferably selected from the group consisting of 2-carboxyethylmethylphosphinic acid, carboxymethylphenylphosphinic acid, 2-methyl-2,5-dioxo-1-oxa-2-phosphorane and carboxyphenylethylphosphinic acid.

It is desired that the polyester resin in accordance with the present invention has an intrinsic viscosity of 0.4 to 0.9 dl/g, preferably 0.5 to 0.8 dl/g (measured at 35° C. using a 0.3 g sample dissolved in 25 ml of ortho-chlorophenol). When its intrinsic viscosity is less than 0.4 dl/g, frequent breakages occur during the drawing process and the film product's mechanical strength becomes poor. When it is greater than 0.9 dl/g, the shear stress increases to cause poor processibility.

In accordance with the present invention, a flame-retardancy enhancing agent is added to the afore-mentioned polyester resin in an amount ranging from 0.05 to 5% by weight based on the weight of the polyester resin, and examples thereof include polytetrafluoroethylene (Teflone), an epoxy- or methacrylate-grafted silicon powder, boron phosphate and aluminum oxide. When the amount of said flame-retardancy enhancing agent is less than 0.05% by weight, the desired flame-retardancy is not achieved. When it is greater than 5% by weight, no more increase of flame-retardancy is obtained.

The flame-retardancy enhancing agent may be added to an ethylene glycol slurry before the polymerization process, or added to a polyester using chips of a masterbatch.

The inventive polyester film may be prepared by melt-extruding a polyester resin composition comprising said additive using a T-die or inflation method to form an undrawn sheet and mono or biaxially drawing the undrawn sheet, followed by heat-setting.

It is preferred that the undrawn sheet is biaxially drawn in the longitudinal direction at a draw ratio of 1.0 to 5.0 and in the transverse direction at a draw ratio of 2.0 to 6.0 at a temperature ranging from 90 to 140° C. The mono or biaxially drawn film may be heat-set at a temperature ranging from 200 to 240° C.

The inventive mono or biaxially oriented polyester film may have a thickness ranging from 15 to 300 μm and may further comprise an interesterification catalyst, polycondensation catalyst, dispersant, stabilizer and other additives. If necessary, the inventive polyester film may be further surface-treated, e.g., corona discharging-treated, and it may be coated, laminated or co-extruded with other resins.

The polyester film in accordance with the present invention has improved flame-retardancy as well as improved processibility, and is useful for electric power cable, communication cable, printed circuit plate, heating unit and the like.

The present invention is further described and illustrated in Examples, which are, however, not intended to limit the scope of the present invention.

The polyester films manufactured in Examples and Comparative Examples were examined for the following properties.

(1) Limited Oxygen Index (L.O.I.)

The limited oxygen index of a film was measured by the ASTM D2863 method using a limited oxygen index measuring instrument which is commercially available from FTT Company.

(2) UL 94 Test (Flame-Retardancy)

The flame-retardancy of a film was determined by vertically placing the film and lighting it.
V-2 : the fire goes out in 60 seconds after the start, and C.I. (Cotton Ignition: the phenomenon that a spark generated by the ignited film causes a cotton sample positioned at 30 cm below to catch fire) is permitted.
V-1: the fire goes out in 60 seconds after the start, and C.I. is not permitted.
V-0: the fire goes out in 30 seconds after the start, and C.I. is not permitted.
   (3) Film Strength

The strength of the film was measured by the ASTM D882 method.

(4) Film Appearance

The appearance of the film was evaluated with the naked eye as follows:
ο: white turbidity is never observed in any event.
Δ: white turbidity is observed in ten sheets of the film overlapped.
×: white turbidity is observed in one sheet of the film.
   (5) Processibility

The processibility of the film was represented by the number of breakage occurred during a continuous operation for 24 hrs.

### EXAMPLE 1

Dimethyl terephthalate and ethylene glycol were mixed in an equivalent ratio of 1:2, and a calcium acetate monohydrate (an interesterification catalyst) was added thereto in an amount of 0.05% by weight based on the weight of dimethyl terephthalate and was kept at 200° C. for 180 min. After the interesterification was completed, 2-carboxyethylmethylphosphinic acid was added to the reaction mixture in an amount of 0.2 equivalent based on the amount of dimethyl terephthalalte, and then, trimethylphosphate (a stabilizer) and antimonytrioxide (a polymerization catalyst) were added thereto in amounts of 0.05% and 0.04% by weight, respectively, based on the weight of dimethyl terephthalate. The mixture was kept at 280° C. for 180 min, to obtain a polyester resin having an intrinsic viscosity of 0.640 dl/g.

5 parts by weight of polytetrafluoroethylene (a flame-retardancy enhancing agent) was added to 100 parts by weight of the polyester resin, and mixed at 285° C. using a compounder screw at a rotation rate of 300 rpm, to prepare a high-concentration master chip.

The polyester resin and the master chip thus obtained were mixed in a weight ratio of 4:1. The mixture was melt-extruded at 280° C. through a conventional T-die and cooled by a casting roller maintained at 25° C., to obtain a sheet. The sheet was drawn at a draw ratio of 3.5 in the longitudinal direction at 90° C., and then, drawn at a ratio of 3.5 in the transverse direction at 120° C., followed by heat-setting at 220° C., to obtain a 100 micron thick biaxially drawn polyester film.

The properties of the resulting biaxially drawn polyester film in terms of L.O.I., UL 94 test, film strength, film appearance and processibility are shown in Table 1.

### EXAMPLE 2 TO 6 AND COMPARATIVE EXAMPLES 1 TO 4

The procedure of Example 1 was repeated employing the specifics shown in Table 1 to obtain various biaxially drawn films, whose properties are listed in Table 1.

TABLE 1

| | | Flame-retardancy | | | | | | |
|---|---|---|---|---|---|---|---|---|
| | Amount of | Enhancing agent | | | | | | |
| | 2-carboxyethylmethyl- | | Amount | Properties of the film | | | | |
| Exam. | phosphinic acid | | (part by | UL 94 | L.O.I. | Strength | Appear- | Processi- |
| No. | (mol %) | Kind | weight) | test | (wt %) | (kg/mm²) | ance | bility |
| 1 | 20 | (A) | 1 | V-0 | 34 | 16 | O | 0 |
| 2 | 10 | (A) | 1 | V-0 | 32 | 18 | O | 0 |
| 3 | 30 | (A) | 1 | V-0 | 35 | 14 | O | 0 |
| 4 | 20 | (B) | 1 | V-0 | 34 | 16 | O | 0 |
| 5 | 20 | (C) | 1 | V-0 | 34 | 17 | O | 0 |
| 6 | 20 | (C) | 1 | V-0 | 33 | 17 | O | 0 |
| Com. | 20 | — | — | V-2 | 32 | 16 | O | 0 |
| Ex. 1 | | | | | | | | |
| Com. | 40 | — | — | V-2 | 33 | 12 | Δ | 4 |
| Ex. 2 | | | | | | | | |
| Com. | 60 | — | — | V-2 | 34 | 9 | X | 8 |
| Ex. 3 | | | | | | | | |
| Com. | 0 | (A) | 1 | Outside | 24 | 19 | O | 0 |
| Ex. 4 | | | | the | | | | |
| | | | | grade | | | | |

(A) polytetrafluoroethylene
(B) methacrylate-grafted silicon powder
(C) aluminum oxide

As shown in Table 1, the films of Examples 1 through 6 show improved flame-retardancy, processibility and the like, as compared with the films of Comparative Examples 1 through 4.

Thus, the inventive oriented polyester films has improved flame-retardancy as well as improved processibility, and it can be advantageously used for electric power cable, communication cable, printed circuit plate, heating unit and other applications.

While the invention has been described with respect to the above specific embodiments, it should be recognized that various modifications and changes may be made to the invention by those skilled in the art which also fall within the scope of the invention as defined by the appended claims.

1. A mono or biaxially oriented, flame-retardant polyester film which comprises: a polyester resin having an intrinsic viscosity of 0.4 to 0.9 dl/g which contains, in its polyester chain derived from dicarboxylic acid and diol components, an incorporated repeat unit of formula (I) in an amount of 10 to 30 mol % based on the amount of dicarboxylic acid, and a flame-retardancy enhancing agent in an amount ranging from 0.05 to 5% by weight based on the weight of the polyester resin: 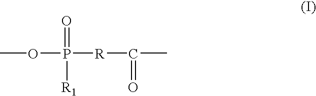
wherein,
R is C₁₋₁₂ saturated alkylene having an optional aryl substituent or arylene group inserted therein, or arylene; and
R₁ is C₁₋₁₂ alkyl having an optional aryl substituent, or aryl.

2. The polyester film of claim 1, wherein the repeat unit of formula (I) is derived using a phosphorus compound selected from the group consisting of 2-carboxyethylmethylphosphinic acid, carboxymethylphenylphosphinic acid, 2-methyl-2,5-dioxo-1-oxa-2-phosphorane and carboxyphenylethylphosphinic acid.

3. The polyester film of claim 2, wherein the polyester resin is prepared by copolymerizing the dicarboxylic acid component, the diol component and the phosphorus compound.

4. The polyester film of claim 1, wherein the flame-retardancy enhancing agent is selected from the group consisting of polytetrafluoroethylene (Teflone), an epoxy- or methacrylate-grafted silicon powder, boron phosphate and aluminum oxide.

5. The polyester film of claim 1, which is drawn in the longitudinal direction at a draw ratio of 1.0 to 5.0 and in the transverse direction at a draw ratio of 2.0 to 6.0, at a temperature ranging from 90 to 140° C.

6. The polyester film of claim 1, which is heat-set at a temperature ranging from 200 to 240° C.
